(19) United States
(12) Patent Application Publication
(10) Pub. No.: US 2009/0094283 A1
(43) Pub. Date: Apr. 9, 2009

(54) ACTIVE USE LOOKUP VIA MOBILE DEVICE

(75) Inventors: Patrick M. Baudisch, Seattle, WA (US); Kevin Ansia Li, Cupertino, CA (US); Kenneth P. Hinckley, Redmond, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 12/163,448

(22) Filed: Jun. 27, 2008

Related U.S. Application Data
(60) Provisional application No. 60/977,278, filed on Oct. 3, 2007.

(51) Int. Cl. G06F 17/30

(52) U.S. Cl. 707/104.1; 707/E17.005

(57) ABSTRACT

A system and methodology that enables a mobile device user to privately retrieve information while engaged in an active communication session is provided. The innovation enables a user to prompt lookup and retrieval of information (e.g., calendar appointments, contact information, task information) without interruption of the active communication session. The content of the information can be configured and conveyed by way of private audible feedback only detectible by the requesting party.

### CROSS-REFERENCE TO RELATED APPLICATION

This application claims the benefit of U.S. Provisional Patent application Ser. No. 60/977,278 entitled “ACTIVE USE LOOKUP VIA MOBILE DEVICE” and filed Oct. 3, 2007. The entirety of the above-noted application is incorporated by reference herein.

### BACKGROUND

With the ever-increasing popularity of personal mobile devices, e.g., cellular phones, smart-phones, personal digital assistants (PDAs), personal music players, laptops, etc., ‘mobility’ has been the focus of many consumer products as well as services of wireless providers. For example, in the telecommunications industry, ‘mobility’ is at the forefront as consumers are no longer restricted by location with regard to communications and computing needs. Rather, today, as technology advances, more and more consumers use portable devices in day-to-day activities, planning and entertainment.

As mobile device popularity increases, the ability to make telephone calls, access calendar appointments, manage tasks, store contact information, retrieve electronic mail, communicate via instant message (IM) and access online services from most any location has also continued to evolve. Although these devices been available for quite some time, conventional devices do not provide seamless integration of available functionalities.

Today, personal information management (PIM) applications are often used to organize e-mail, manage calendar entries, track tasks, manage contacts, provide note taking and enable journaling. These PIM applications can be used as stand-alone applications or implemented in conjunction with a server which provides enhanced functions, e.g., for multiple users in an organization. For instance, the server can provide multiple users ability to share mailboxes, calendars, folders and meeting time allocations.

Essentially, a PIM application can refer to an information management tool or application that functions as a personal organizer. One main purpose of a PIM is to provide management (e.g., recording, tracking) of information such as calendar entries, contact information, journals, tasks, e-mail or the like. When used in conjunction with a server, a PIM is capable of synchronizing data via a network (e.g., Internet, intranet) as well as rendering or conveying information to other users. For example, via the network, and so long as proper permissions are in place, a user can view calendar entries, e-mails, or other PIM data related to another user's account.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that enables a mobile device user to privately access personal information manager (PIM) data while engaged in an active call. In other words, the innovation enables a user to prompt lookup and retrieval of information without interruption of the active call. It will be appreciated that the information can include most any information including PIM (personal information manager) data such as contacts, calendar entries, tasks or the like. In accordance with the innovation, while engaged in an active call, a user can privately access PIM information without the other party to the call being aware or disclosing such information to the other party.

In other aspects, a user can privately (and/or automatically) generate PIM data (e.g., calendar entries, contact entries) while engaged in conversation with another party. Additionally, PIM data can be updated, for example, to schedule an appointment as a result of a calendar query. Aspects provide for private audible playback of the information to the user. For example, auditory tones or other distinctive sounds can be used to convey ‘busy’ versus ‘free’ time slots in a calendar. As well, if desired, speech can be used to convey availability related to a calendar entry.

In yet another aspect thereof, a machine learning and reasoning component is provided that employs a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example system that facilitates uninterrupted access of information via a mobile device in accordance with an aspect of the innovation.

FIG. 2 illustrates an example flow chart of procedures that facilitate retrieving and privately rendering (e.g., audibly) queried data while on an active call in accordance with an aspect of the innovation.

FIG. 3 illustrates an example block diagram of a system that employs request and data management components that privately manage information while engaged in an active communication session.

FIG. 4 illustrates example interface menus in accordance with aspects of the innovation.

FIG. 5 illustrates example interface mappings in accordance with aspects of the innovation.

FIG. 6 illustrates an example block diagram of a system that employs request retrieval and analysis components to establish information desired by a user in accordance with aspects of the innovation.

FIG. 7 illustrates an example block diagram of a system that employs data retrieval, rendering and update components that locate, access, deliver and/or modify data in accordance with aspects of the innovation.

FIG. 8 illustrates an example block diagram of a system that employs a machine learning and reasoning component that infers and/or automates an action(s) on behalf of a user.

FIG. 9 illustrates a block diagram of a computer operable to execute the disclosed architecture.

FIG. 10 illustrates a schematic block diagram of an example computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

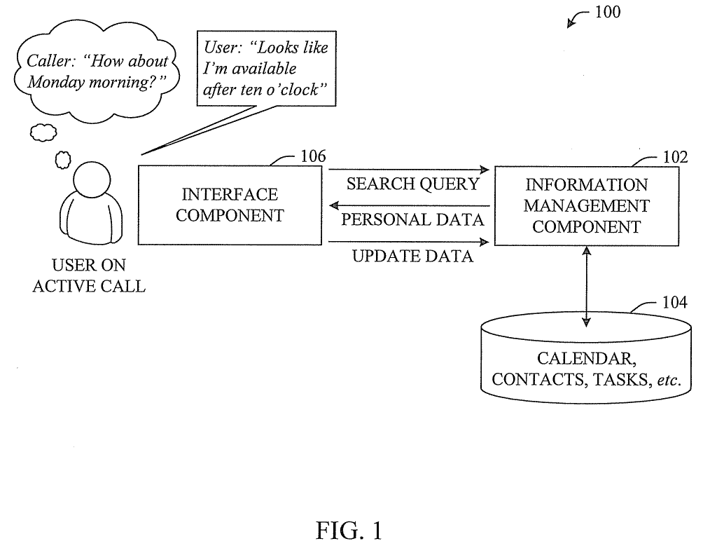

Referring initially to the drawings, FIG. 1 illustrates a system 100 that facilitates a mobile device user to privately access, lookup and retrieve information (e.g., personal information manager (PIM) data, data accessed via a web browser, data in local or remote stores . . . ) while engaged upon an active call. In aspects, the features, functions and benefits of the innovation can assist visually impaired users, users in situations where their attention is focused elsewhere (e.g., while walking, driving a car . . . ). Additionally, the innovation can be employed with devices with displays, such as screen-less mobile communications devices.

It is to be understood and appreciated that a mobile device refers to most any mobile or portable communications device including but, not limited to, a cellular phone, smart-phone, personal digital assistant (PDA), personal media player, palm-top computer, laptop, etc. Effectively, the innovation enables a user to lookup information while in an active communication session (e.g., voice call). This information can be queried and retrieved without interruption to the active communication session.

Today, many mobile devices integrate services (or otherwise have remote/network access to services) such as personal calendars. Given the social nature of the stored data, however, users often need to access such information as part of an ongoing or ‘live’ phone conversation. In typical, non-headset use, this often requires users to interrupt their conversations to look at the keyboard and/or the screen.

The subject innovation, in one aspect thereof, enables ‘eyes-free’ access to information (e.g., PIM data) stored on the phone (or accessed there from). In one example, the system 100 enables this access via private auditory feedback. The auditory feedback can be sounds, words, or combinations thereof. In other words, this feedback is heard only by the user or requester, e.g., not by the person on the other end of the line.

Generally, the system 100 includes an information management component 102 that accesses data from a store 104 in response to requests and instructions received via an interface component 106. In operation, a user can control or trigger access using the interface component 106 (e.g., phone keypad) while the phone is held up against the user's ear. As will be discussed and described infra, alternative designs and configurations of interface component 106 can be employed to enhance user interaction with the system 100.

The store 104 is capable of maintaining PIM data or information such as calendar appointments, contact information, tasks, journal entries, etc. Aspects of the innovation employ a local (e.g., on-board a mobile device) store 104 while other aspects can employ remotely located (as well as distributed) stores. For instance, the store 104 can be located within a cloud and accessed via the Internet in one aspect. In other aspects, portions of the information can be located in a cloud while other portions can be located and retrieved from an on-board storage device 104. Still further, data can be indexed locally and retrieved remotely as desired. These aspects are to be considered a part of the innovation and claims appended hereto.

In operation, while engaged within an active communication session, a user can search information without interrupting the active communication session. For instance, as shown, when scheduling a meeting, a caller can ask, “How about Monday morning?” In accordance with the innovation, the user can seamlessly (and privately) search an information store (e.g., 104) by way an interface component 106 together with an on-board information management component 102. Thus, information can be retrieved and the user can be privately notified of appointment availability.

It will be understood that most any notification protocol can be used to inform the user, for example, silence, private audible sounds, verbal messages, vibratory cues, visual cues, etc. For example, in a scenario where private audible messages are sent to the user, here, the information management component 102 can automatically ‘mute’ the phone so as to keep the information private from the other party to the call. Once the information is conveyed to the user, the information management component 102 can automatically toggle off the ‘mute’ feature to enable the user to respond to the caller's inquiry, e.g., “Looks like I'm available after ten o'clock.”

This and other examples will become more evident upon a review of the figures that follow. It is to be understood that the examples described herein are provided merely to add perspective to the innovation and are not intended to limit the innovation in any manner. Accordingly, other aspects and scenarios exist that are to be included within the scope of this disclosure and claims appended hereto.

As shown in the example of FIG. 1, a user can trigger a search query for information, e.g., PIM data. This personal data can be privately conveyed to the user. If desired, the user can prompt an update (or other modification/creation) of data. For instance, once it is determined that the user is available after ten o'clock, the user can trigger an instruction to block out the time in the calendar to reserve the appointment time. In alternative embodiments, particulars (e.g., subject, location . . . ) can be added upon generating the entry. Alternatively, the time slot can be block with minimal information to be supplemented later by the user, for example, via a desktop computer.

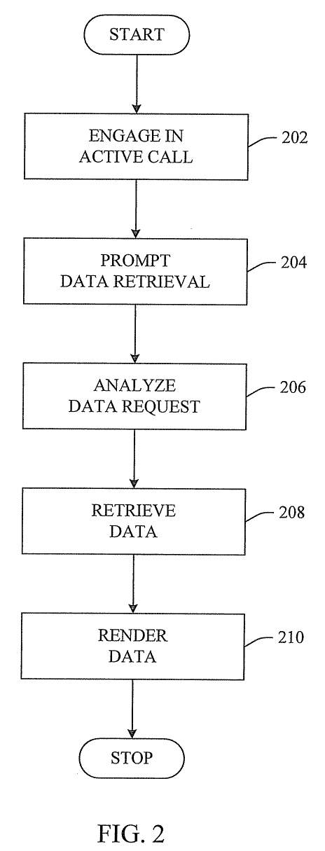

FIG. 2 illustrates a methodology of seamlessly (and privately) retrieving information via a mobile device in accordance with an aspect of the innovation. While, for purposes of simplicity of explanation, the methodology shown herein, e.g., in the form of a flow chart, is shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, a user engages in an active or ‘live’ call or communication session. It is to be understood that a communication session can include, but is not limited to, a cellular phone call, a voice-over Internet Protocol (VoIP) call or the like. For example, a user can be engaged in an active call via a cellular phone or smart-phone. While on the call, the user may have reason to access PIM data, for example, in response to an inquiry from the other party to the communication. In another example, a user might want to check calendar entries so as to not miss the start of a subsequent appointment. It will be appreciated that many reasons exist as to why a user may desire to access information while engaged within an active communication session.

At 204, data retrieval can be prompted. For instance, in one example, a keyboard (e.g., hot-keys) can be used to trigger information lookup. As described above, most any triggering mechanisms can be used in accordance with alternative embodiments of the innovation. Specially designed controls, buttons, navigation devices, etc. can be employed to trigger retrieval.

The data request can be analyzed at 206. For example, where the search query (or request) is in the form of a spoken phrase, the innovation can employ speech recognition features to determine desired information. Still further, it will be understood that keys can be preprogrammed for specific functionality, for example, “lookup next appointment.” In one example, in order to accommodate a common ergonomic position of holding a mobile device to one's ear, buttons can be place on the rear of the phone so as to accommodate ease of use by the user's fingers. In other examples, keys or buttons can be equipped with navigational designators (e.g., tactile features such as raised epoxy dots) to assist a user in locating desired navigational keys without interrupting the ‘live’ session.

Other input mechanisms and/or devices can be employed in aspects without departing from the spirit and/or scope of this disclosure and claims appended hereto. For example, other aspects can employ ‘tactile’ feedback on a thumbwheel, e.g., those with detents. Other optical navigational devices such as ‘soap’ can be employed in still other aspects. It is to be understood that ‘soap’ refers to a pointing device primarily based on hardware found in a mouse, yet works in mid-air. Soap employs an optical sensor device moving freely inside a hull made of fabric. As the user applies pressure from the outside, the optical sensor moves independent from the hull. The optical sensor perceives this relative motion and reports it as position input.

Yet other aspects employ gesture input, such as marking menus as well as ‘earPod,’ which is based on a touch pad with an overlay that limits navigational access to a specifically shaped (e.g., round) area. EarPod partitions this round area into zones, e.g., 4 or 8 zones, each corresponding to one menu item. This partitioning allows experienced users to operate menus without iterating. In addition, earPod provides users with auditory feedback as they drag their finger between zones. As will be appreciated, this allows inexperienced users to learn menu choices without looking.

The data can be retrieved at 208 and rendered or conveyed to a user at 210. It will be understood that most any method of rendering can be used without departing from the spirit and/or scope of the innovation. For instance, silence can convey that no conflicts exist in accordance with a calendar appointment request. Other notification protocols such as auditory (spoken phrases, tones), vibratory cues, visual (e.g., lights) cues, etc. can be employed in alternative aspects of the innovation. Still further, in alternative aspects, it is to be understood that artificial intelligence and machine learning & reasoning (MLR) mechanisms can be employed to automate features and actions on a user's behalf.

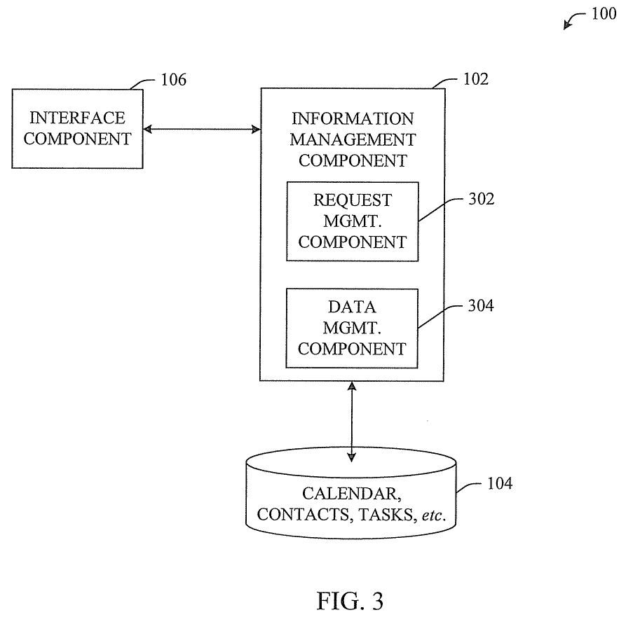

Turning now to FIG. 3, an alternative block diagram of system 100. Generally, the information management component 102 can include a request management component 302 and a data management component 304. Together, these sub-components (302, 304) enable interpretation of a user's request as well as retrieval and rendering of the information to a user. As will be seen upon a review of the discussion that follows, the data management component 304 can also facilitate modification of data as desired.

As described above, today, many mobile devices integrate services (or access to services) such as personal calendars, contacts, etc. (e.g., PIM data). Given the social nature of the stored data, however, users often need to access such information as part of a phone conversation or other communication session. In typical, non-headset use, this most often requires users to interrupt their conversations to look at the screen.

In accordance with this scenario, the innovation provides for ‘eyes-free’ access to information stored on the phone. In one example aspect, the system 100 enables ‘eyes-free’ access via auditory feedback. It is to be understood that ‘auditory feedback’ can include any sound including, but not limited to, spoken words, tones, beeps, white noise, etc. In order to keep the information private and not to disrupt the flow of the live communication session, this feedback can be masked and only heard by the user, not by the person on the other end of the line. If desired, other aspects can make the information available to both (or multiple) parties of the session.

In one aspect, the interface component 106 can be a standard or specialized keypad which can be employed to trigger information access while the phone is held up against the user's ear. Essentially, the system 100 can be designed to minimize interference between auditory feedback and phone conversation by making the rendering of the information private to a party requesting such information. In other words, when a user requests information via the interface component 106, the information management component 102 can privately render the information without disruption to the flow of the live communication session.

The innovation presents two example user studies. The first study verifies that useful keypress accuracy can be obtained for the phone-at ear position. The second study compares the innovation against a visual baseline condition. Essentially, the second study solicited participants to access their contact list and negotiate calendar appointments interactively and ‘eyes-free’ while talking on the phone. Subjective results indicate a strong preference for the ‘eyes-free’ aspects of the innovation over the visual baseline condition.

As described above, today, many mobile devices integrate functionality traditionally spread across multiple devices. Accordingly, the devices are often referred to as ‘smart’ devices or phones. These ‘smart’ devices offer, for example, locally stored (or access to remotely stored) personal calendars in addition to contact lists and phone functionality. Since personal information is particularly important in social scenarios, users often need to access it while actively talking on the phone. Below is an example scenario as to how access to this information can impact ‘live’ phone conversations when using a traditional visual baseline device:
John: Hi Ami, can we meet sometime next week?
Ami: Let me check my calendar. Hold on.
   Ami moves her phone away from her ear so she can view the display. She opens the calendar application and navigates to next week.
   When did you have in mind?
John: How about Tuesday morning sometime?
Ami: Let me check. Hold on.
   Ami looks at her phone again, navigates to Tuesday, inspects it, then she puts her phone back to her ear.
   What did you say? Oh, yeah, no . . . I'm only free 3-4.
John: Sorry, I have meetings all afternoon. How does Wednesday afternoon look?
Ami: Hold on, let me see . . .

As will be understood, the traditional interaction model requires users to look at the screen, which is virtually impossible while the phone is held against the user's ear. Moving the phone back and forth to the ear interferes with the conversation. Unfortunately, this disruption is commonplace with conventional devices and systems.

Although headsets can potentially alleviate some of the issues related to conventional devices and systems, they are well entrenched in certain user groups and in some cultural settings. Many users do not use headsets because they interfere with real-world situational awareness and are often judged as uncomfortable, unattractive, or socially awkward. Even with a headset, accessing visual information requires looking at the screen, which can interfere with other tasks requiring visual attention, such as walking or driving. It will be appreciated that speakerphones are subject to the same limitations; in addition they can raise privacy concerns.

Contrary to conventional systems, the innovation can provide users with ‘sightless’ access to personal information stored on their mobile device (or accessible from their mobile device) while actively engaged in conversation. As shown in FIG. 3, users control the access to information using the interface component 106 (e.g., a built-in phone keypad). The request management component 302 can analyze the request (e.g., instruction, query . . . ) received from the user. Subsequently, the data management component 304 can locate, access and deliver information and confirmations, e.g., via auditory feedback heard only by the user, not by the person on the other end of the line.

In developing the innovation, a formative survey of a group of users revealed that people often need/want information access during phone conversations. This situation is often found to be problematic with conventional visually-driven phone interfaces. Calendar access and Add Contact features were two of the most common in-conversation actions requested by survey participants. While specific examples of the ‘sightless’ management of information are described herein, it is to be understood that these examples are provided to add perspective to the innovation and are not intended to limit the innovation in any manner.

The innovation presents a series of possible modifications to consumer phones that enable ‘eyes-free’, one-handed operation for data management. Studies have indicated that users can achieve eyes-free error-rates below 5%. Experiments also reveal that the overhead for eyes-free use is approximately 200 ms per keystroke compared to sighted use. In a qualitative user study, 7 out of 8 of participants indicated a preference or strong preference for the ‘eyes-free’ system of the innovation over a traditional smart mobile phone which requires visual navigation.

Aspects of the innovation can be described in two example categories: auditory feedback and mobile input. The auditory feedback can be used to convey content of personal data (e.g., PIM data). In operation, the information management component 102, via the request and data management sub-components (302, 304) can enable analysis, access, configuration and rendering of the data. The input (e.g., query, modification) data can be conveyed by a user via the interface component 106, which can include specially designed buttons, navigational devices, sensors, recognition systems or the like. Each of these two example categories will be described in greater detail below.

Turning first to a discussion of the auditory feedback provided by the request and data management sub-components (302, 304), strengths and weaknesses of auditory feedback have been studied extensively in the field of interactive voice response systems. One of the main challenges is that audio prompting forces users to wait (resulting in ‘touch tone hell’). It is therefore often desirable to enable users to ‘dial through’ to interrupt prompts, or ‘dial ahead’ to skip familiar prompts. Thus the innovation, in aspects, enables users to dial ahead using keypad entry as well as to iterate through menu options on a telephone using forward and backwards keys, rather than having to listen to a prompt. In other aspects, users can jump directly to a location using shortcuts, e.g., via interface component 106.

While most any human-human conversation contains a certain amount of redundancy, weaving auditory information into the phone conversation can risk interference. Thus, the innovation can alleviate interference by time-compressing utterances and then serializing them. Other aspects leave out words with increasing playback speed. It will be understood that non-speech audio may be less distracting than speech audio and can be used to convey information such as navigational cues in hierarchical menus. Thus, aspects of the innovation employ non-speech or non-verbal cues to convey information, for example, location in a menu, ‘busy’ versus ‘free’ time slots, etc.

Referring now to a discussion of the input via the interface component 106, the innovation allows for one-handed ‘eyes-free’ input, for example using a keypad. Keyboard-based entry with few buttons can be supported through iteration or through chording. In some aspects, gestures can enable users to perform eyes-free operations. To facilitate ‘eyes-free’ operation, one of the form factors explored receives input on the back of the device, e.g., via buttons, keys, joystick, sensor pads, etc.

As described above, the interface component 106 can also be equipped with voice recognition functionality. Since speech input can interfere with the conversations, aspects can optionally employ a ‘mute’ button so as to privatize the user's commands from the other party to the conversation.

In one example, auditory eyes-free interaction is triggered via the interface component 106. Users can control the interaction by pressing buttons on their phone (e.g., via interface component 106) and receive confirmation by means of auditory feedback (e.g., via information management component 102). Following is a discussion of a design rationale of an example auditory menu, menu organization, and a walkthrough of the innovation.

One rationale behind using auditory feedback during a phone conversation is that most any human-human conversation contains a certain amount of redundancy. If part of the conversation is lost, e.g., because of drop-outs in the line or because a loud truck drove by, users can typically continue the conversation, as long as the inference is short and does not take place at a critical moment.

The innovation provides feedback on-demand, e.g., via the interface component 106. In other words, the information management component 102 plays auditory feedback in response to a user request triggered by way of the interface component 106. It will be appreciated that, putting timing under user control allows users to wait for an appropriate moment and to avoid moments where important information is communicated, such as a phone number.

In an effort to minimize interruption of an active communication, the innovation considers brevity in its audible feedback. Accordingly, the innovation administers audio feedback in brief chunks, for example, a single syllable whenever possible. As will be understood, reducing duration of the audible feedback can minimize the risk of interference with the conversation.

To avoid long blocks of auditory feedback, the innovation can automatically break down (or decompose) composites, such as lists of menu items or appointments. Rather than presenting the items or appointments all at once, users can selectively iterate though them separately initiating the playback of each item as desired. When iterating through the calendar in 30 minute steps, for example, each step results in only 1-2 syllables conveying time and availability of the current time slot. Similarly, users can block out a calendar item by repeatedly pressing a key (e.g., block and advance), rather than entering start and end time.

The innovation is capable of enabling non-speech previews of composites. For example, to give previews for 3-hour and full-day calendar views, the innovation can present composites in their entirety. These previews can be created as a concatenation of 40 ms earcons (e.g., white noise for ‘available’ or ‘free’ and a buzzing sound for ‘blocked out’ or ‘busy’) with 20 ms spaces in-between. It is to be understood that this is but one example of auditory feedback. This use of non-speech audio minimizes feedback length.

One goal of the innovation is to minimize interruption to an active or ‘live’ communication session. By aiming for brevity and decomposition, most auditory elements can be conveyed in one or two syllable segments. It is to be appreciated that exceptions can exist. For example, exceptions are the task names forming the main menu (such as ‘hear text messages’). It will be appreciated that full names can be employed to allow for improved discoverability and learnability which has been shown useful in an eyes-free system. To minimize interference with the conversation, the innovation allows users to interrupt audio playback as desired.

In aspects, the main menu of the interface component 106 combines several of the principles listed above. Accordingly, the main menu can be quiet when entered, also referred to as ‘on-demand feedback.’ Depressing a button triggers the system to speak out only that button's functionality, such as ‘add contact’ (decomposition, discoverability). Subsequent key or button depression enters the menu for the respective function. As will be understood, experienced users can preempt the announcement of the menu name by double-pressing in quick succession (interruptability), which can turn out to be faster than the use of a separate confirm button. Other aspects can employ a separate ‘confirm’ button. It is to be understood that the configuration and functionality described herein exemplify aspects of the innovation and are not intended to limit the innovation in any manner.

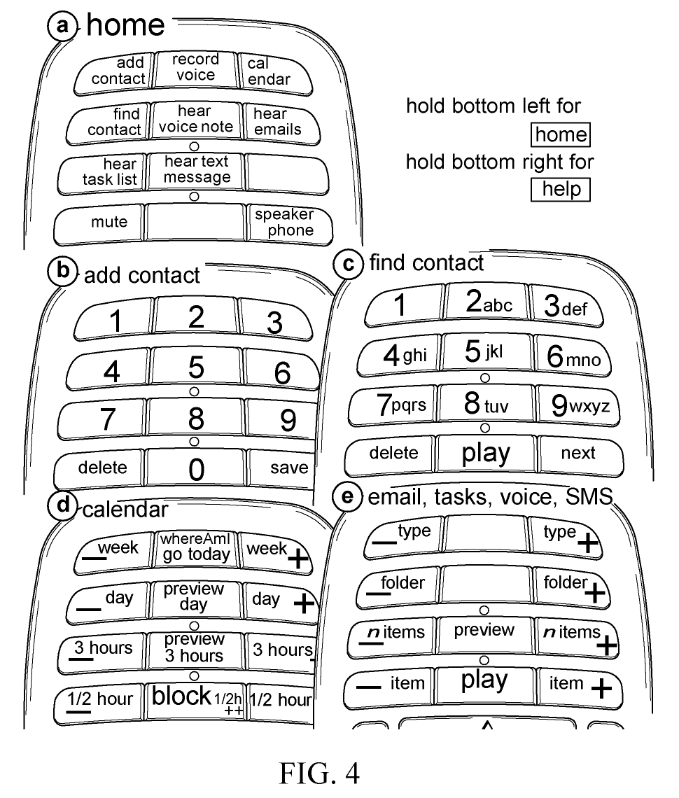

FIG. 4 illustrates an example interface menu structure in accordance with an aspect of the innovation. As shown, the example menus are based on the 3×4 key numeric portion of a traditional phone keypad, e.g., without additional buttons such as a directional-pad or soft keys. However, other aspects exist that employ additional buttons and/or configurations as appropriate or desired.

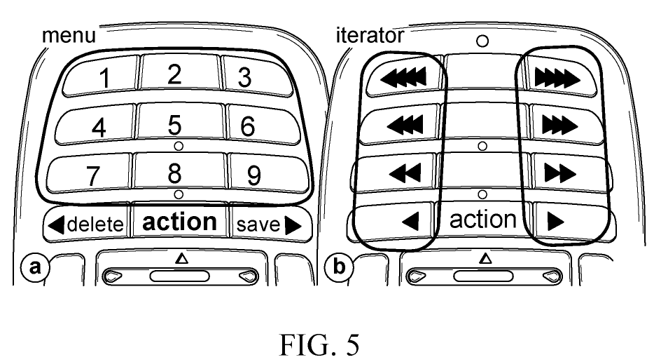

In aspects, each menu is derived from one of the two patterns shown in FIG. 5. The ‘menu’ pattern offers fast access to menus containing a small number of choices, and also works for digits and T9 text entry. The menu mapping affords the entry of a small number of choices, such as digits, characters, or menu functions. The ‘iterator’ pattern, in contrast, allows users to traverse long lists using different step sizes or contents organized in a hierarchy (or otherwise). The iterator mapping affords selection from a long or non-finite list of choices.

The ‘home,’ ‘find contact,’ and ‘add contact’ menus of FIGS. 4A-C follow the ‘menu’ pattern; all other menus follow the ‘iterator’ pattern. In this example, it can be considered to implement ‘find contact’ using an ‘iterator’ pattern, but the aspect employs a faster and quite common approach of pre-filtering by typing part of the desired name or phone number using T9. To keep the responses short, the innovation can respond with the number of matches rather than by spelling out matches. When users decide that the number of matches is small enough, they can therefore iterate through the remaining choices.

As illustrated in FIG. 4, each example submenu implements a particular task, for example, Add Contact, Find Contact as separate tasks, and Calendar as one task. In this aspect, Add Contact and Calendar are assigned to the prominent corner positions as illustrated in FIG. 4A.

It will be appreciated that mode switches can be generally considered problematic, and can be even more problematic for eyes-free applications. Accordingly, the aspect illustrated minimizes mode switching by avoiding multi-step menus or wizards. For example, the innovation derives calendar from the ‘iterator’ pattern. In the example design shown in FIG. 4, each submenu holds the entire interface required for completing a task. The main menu functions Mute, Speakerphone, and Record Voice simply toggle the respective function, again avoiding mode switches.

In one aspect, the innovation limits the information users can enter to information that is employed for the task and defers the entry of all additional information until after the phone call. Add Contact, for example, can allow users to add a phone number, but it does not allow (or require) entering a name for that number. Rather, the phone number can be auto-filed with a particular naming convention, for example, under ‘.blindSight filed <date><time>.’ The same holds for new appointments. It will be appreciated that deferring the entry of less relevant data until after the call can minimize in-call interaction time and thus minimizes the impact on the conversation.

Following is an example walkthrough to provide context to the innovation. More particularly, the scenario described above is now described in accordance with an aspect of the innovation. In this example walkthrough, interactions are identified as: [symbol] followed by the resulting “audio response”. While this presentation style suggests turn-taking between human-human and human-phone interactions, the interactions typically take place ‘in-parallel’ with the spoken dialog, as discussed earlier. It is to be understood that this in parallel interaction often alleviates wait times altogether. Below is the example walkthrough:

| | |
|---|---|
| John: | Hi Ami, this is John, can we meet sometime next week? |
| Ami: | Oh, hi John. Yeah, sounds great. When did you have in mind? |
| | 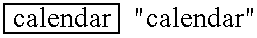 |
| | 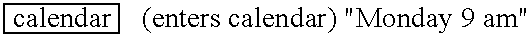 |
| | 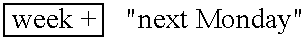 |
| John: | How about Tuesday morning sometime? |
| Ami: | 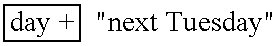 |
| | 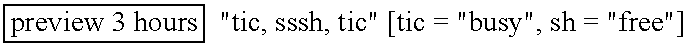 |
| | Ami realizes that noon is taken & looks for alternatives |
| | 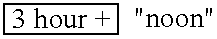 |
| | 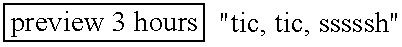 |
| | I'm busy in the morning, but I am free in the early afternoon. |
| John: | Sorry, I have meetings all afternoon. How does Wednesday afternoon look? |
| Ami: | 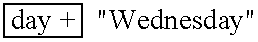 |
| | 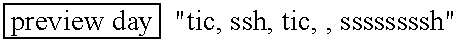 |
| | Yeah, Wednesday sounds good. I am free after 1. |
| John: | Ok, let's make it one then. Call me on my mobile phone if anything comes up. |
| Ami: | 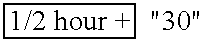 |
| | 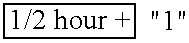 |
| | 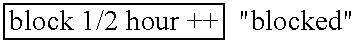 |
| | Will do, can you give me your number again? |
| | 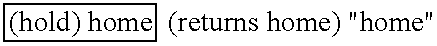 |
| | 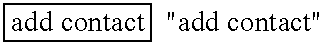 |
| | 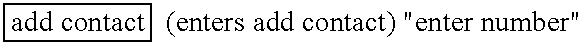 |
| John: | Sure, do you have something to write with? |
| Ami: | Yep! |
| John: | It is (206) . . . 555 . . . 7324. Got it |
| Ami | 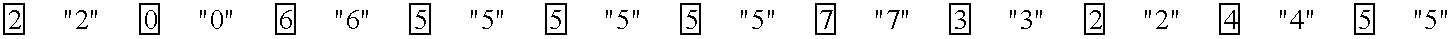 |
| | 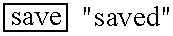 |
| | (returns home) “home” |
| | Of course. Oh, and if anything comes up, call me at the AI lab, their number is . . . |
| | 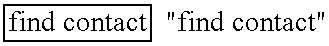 |
| | 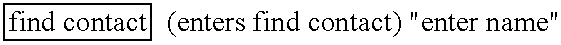 |
| | 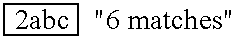 |
| | 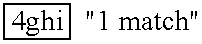 |
| | 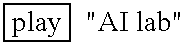 |
| | 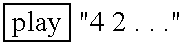 |
| John: | Hold on, let me get something to write with . . . |

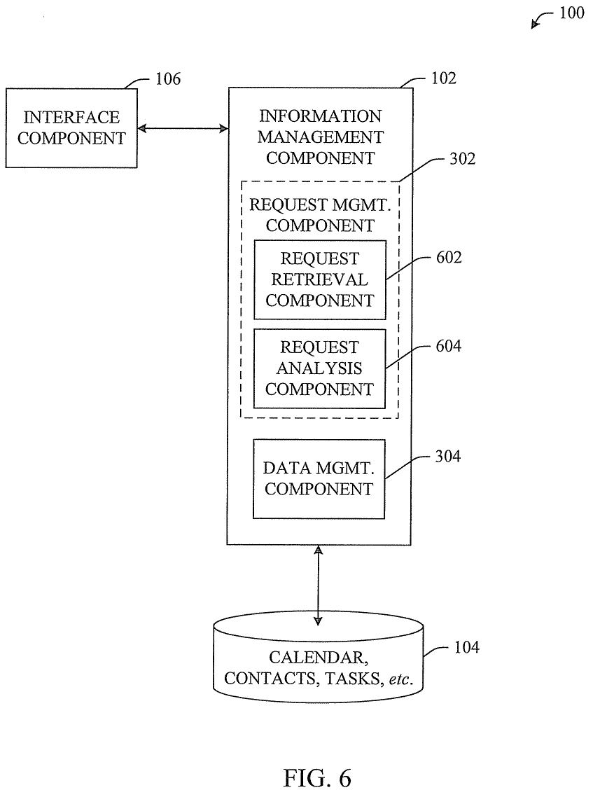

Turning now to FIG. 6, an alternative block diagram of a system 100 in accordance with an aspect of the innovation is illustrated. More particularly, FIG. 6 illustrates sub-components integral to the request management component 302. These sub-components include a request retrieval component 602 and a request analysis component 604. Together, these sub-components facilitate a user to seamlessly (and privately) retrieve information while engaged in an active communication session. More particularly, these sub-components (602, 604) enable retrieval and analysis of a user request generated by way of interface component 106.

As described supra, many mobile devices are capable of integration of (or network access to) services such as personal calendars (and other PIM data). Given the social nature of the stored data, however, users often need (or desire) to access such information as part of (or during) an active phone conversation. In typical non-headset use, access of this information during an active communication session requires users to interrupt their conversations to look at the screen in order to retrieve PIM data. For example, when scheduling an appointment during a live call using a conventional device, users would have to visually access the information via a device display.

The subject innovation discloses ‘eyes-free’ access to information stored on the phone (or within a remote store). In aspects, the innovation enables conveyance of this information via private auditory feedback. As well, in other aspects, the information can be conveyed via other notification protocols including, but not limited to, visual and vibratory feedback.

In operation, a request is received by the request retrieval component 602 and evaluated by the request analysis component 604. Essentially, the evaluation identifies the scope and other details of the request. For instance, the request can identify if a user is interested in a calendar entry, contact information, etc. Additionally, the details of the request (e.g., date, time, name, . . . ) can be established by interpreting the request information and signals received from the interface component 106.

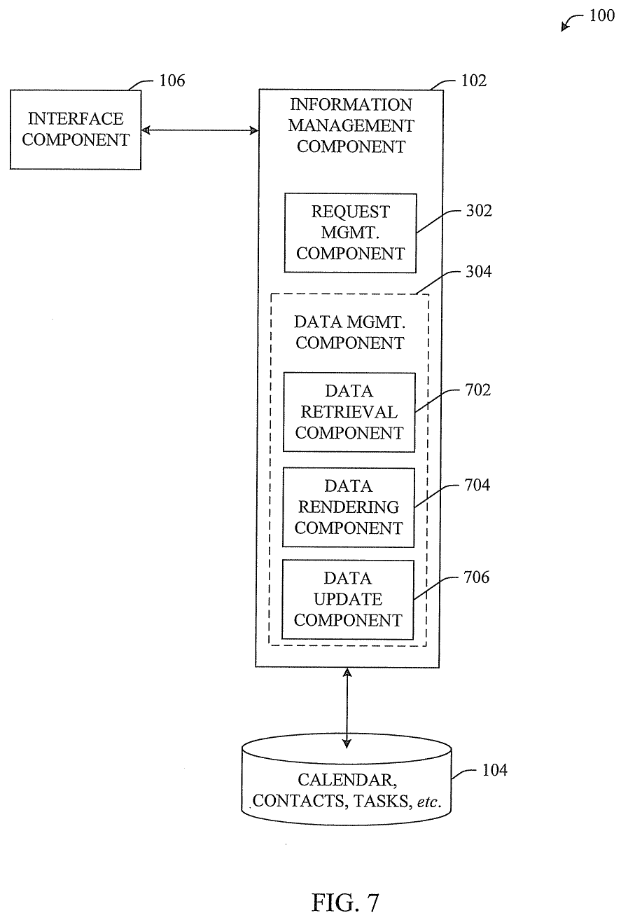

FIG. 7 illustrates yet another alternative block diagram of system 100 in accordance with an aspect of the innovation. Generally, FIG. 7 illustrates that the data management component 304 can include a data retrieval component 702, a data rendering component 704 as well as an optional data update component 706. These sub-components (702, 704, 706) enable location, access, delivery as well as optional update (or generation) of data.

The data retrieval component 702 can locate the data based upon the analysis received from the request management component 302. In one aspect, the data is stored locally, for example, in local memory. In other aspects, the data can be stored remotely, for example, on a network accessible server. Still further, data can be stored in multiple locations as appropriate or desired. Regardless of the location, the data retrieval component 702 can be employed to locate and retrieve the requested information.

The data rendering component 704 can configure and render (e.g., deliver) the information to a user. For example, data can be compressed or converted into appropriate audible notifications in order to convey the content of the information. In one example, suppose a user inquires of their availability to schedule a meeting on a given day and time. Here, the information can be retrieved by the data retrieval component 702 and converted into an appropriate audible notification to convey the availability to the user. In one aspect, a series of tones and white noises can be used to inform a user of availability during the requested time slot. As described above, the user can navigate to time slots before and after in order to search the calendar. Accordingly, the illustrated and discussed sub-components can be employed to identify, locate, access, configure and render notifications and/or signals to a user.

Moreover, as described supra, these notifications and/or signals can be conveyed privately without interrupting the flow of an active conversation. In other words, the information can be masked from the non-requesting party to the call.

Still further, as described supra, a data update component 706 can be employed to modify, create and/or update data. In examples, calendar and contact entries can be created or modified. Here, time slots can be blocked with sparse information and supplemented at a later time. Similarly, as described supra, sparse contact entries can be generated and supplemented at a later time.

Effectively, the innovation enables private PIM data feedback during an active communication session. In a scenario of auditory feedback, this feedback is heard only by the user, e.g., not by the person on the other end of the line. Users can control this functionality using the phone keypad while the phone is held up against the user's ear. In other aspects, other buttons or triggering mechanisms (e.g., keywords) can be employed without departing from the spirit and/or scope of the innovation. Essentially, the innovation enables a user to retrieve information without a need to view the device display to read text. Here, the innovation can be employed to minimize (or possibly eliminate) interference caused by the auditory feedback to on-going phone conversation.

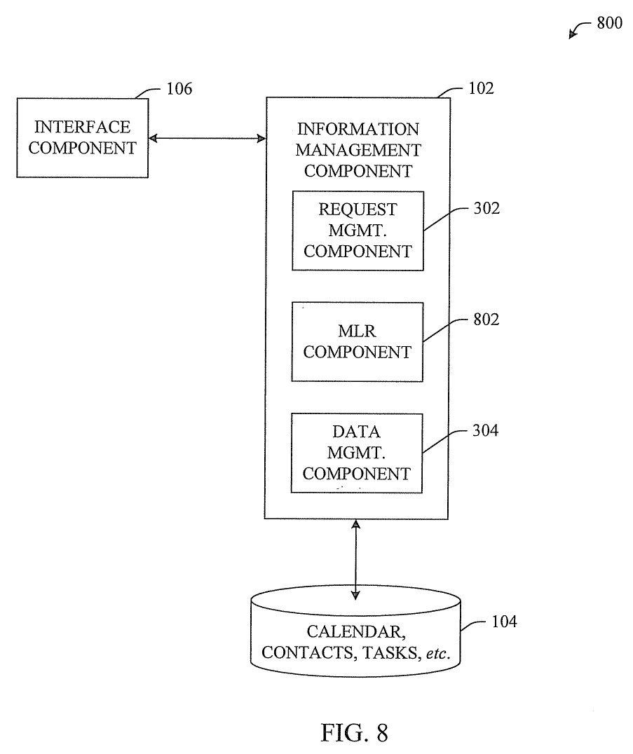

FIG. 8 illustrates a system 800 that employs an MLR component 802 which facilitates automating one or more features in accordance with the subject innovation. It is to be understood that MLR is optional to the innovation and can be employed in alternative aspects without limiting the scope of the core functionality described above. The subject innovation (e.g., in connection with data lookup, configuration, rendering, . . . ) can employ various MLR-based schemes for carrying out various aspects thereof. For example, a process for determining when to access PIM data, how to convey the data, etc. can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when to access PIM data, what data to retrieve, how to configure interpretation of the data, how to render the data, etc.

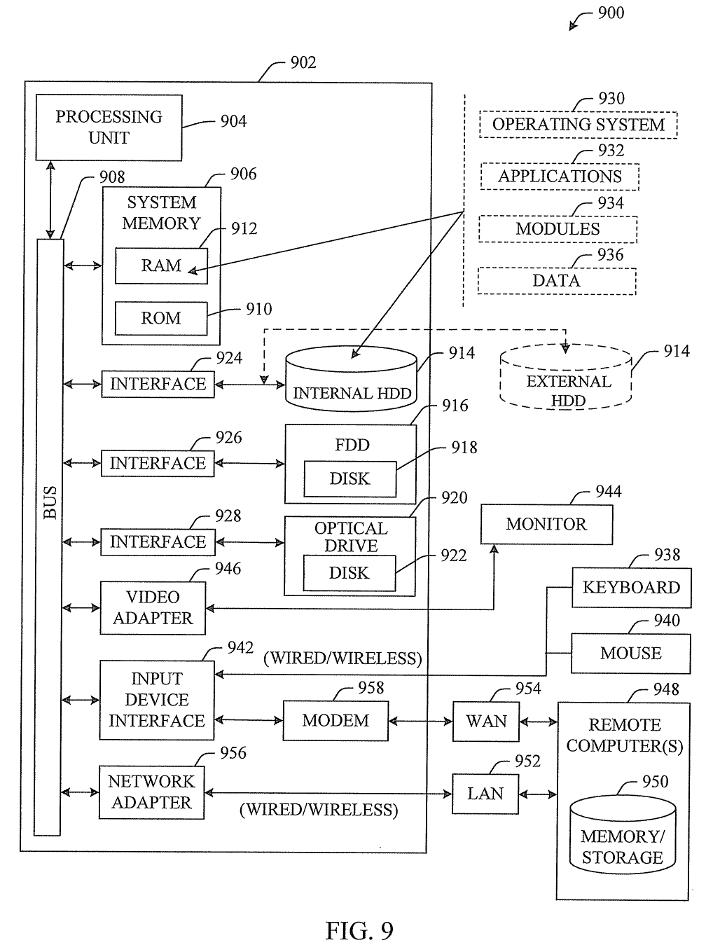

Referring now to FIG. 9, there is illustrated a block diagram of a computer operable to execute the disclosed architecture. In order to provide additional context for various aspects of the subject innovation, FIG. 9 and the following discussion are intended to provide a brief, general description of a suitable computing environment 900 in which the various aspects of the innovation can be implemented. It is to be understood that this is but one example environment for the innovation and it provided to add perspective to the innovation. Thus, other example environments include, but are not limited to, smart-phones, cellular phones, pocket computers, personal digital assistants, communication-equipped mobile devices or the like. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the innovation includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the innovation can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

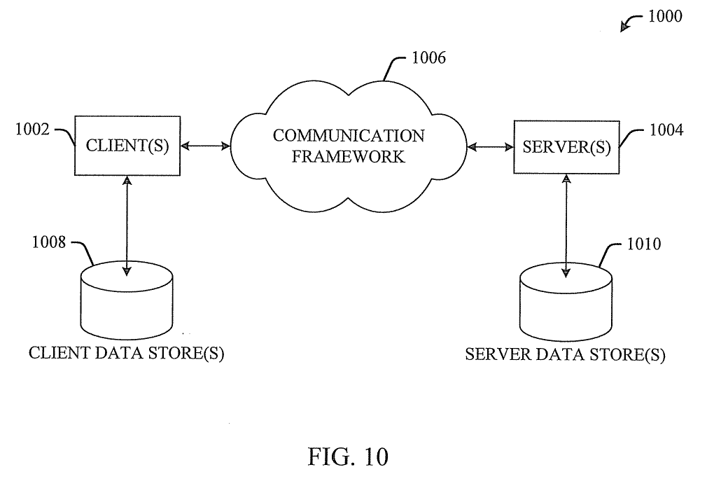

Referring now to FIG. 10, there is illustrated a schematic block diagram of an exemplary computing environment 1000 in accordance with the subject innovation. The system 1000 includes one or more client(s) 1002. The client(s) 1002 can be hardware and/or software (e.g., threads, processes, computing devices). The client(s) 1002 can house cookie(s) and/or associated contextual information by employing the innovation, for example.

The system 1000 also includes one or more server(s) 1004. The server(s) 1004 can also be hardware and/or software (e.g., threads, processes, computing devices). The servers 1004 can house threads to perform transformations by employing the innovation, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates private data access via a mobile device, comprising:
an interface component that generates a request for data from a user;
an information management component that retrieves the request for data and privately conveys an audible representation of a subset of the data to the user during an active communication session.

2. The system of claim 1, wherein the data is at least one of calendar data, contact data, task data, data accessed via a web browser, or data accessed via one of a local or remote store.

3. The system of claim 1, wherein the interface component is configured to facilitate sightless operation by the user, wherein the mobile device is a screen-less mobile device.

4. The system of claim 1, further comprising a request management component that evaluates the request and identifies the data.

5. The system of claim 1, further comprising:
a request retrieval component that receives the request from the interface; and
a request analysis component that identifies the data based at least in part upon content of the request.

6. The system of claim 1, further comprising a data management component that retrieves and renders the subset of the data to the interface component.

7. The system of claim 6, further comprising a data retrieval component that identifies a store and accesses the data from the store based upon the request.

8. The system of claim 6, further comprising a data rendering component that audibly renders the data to the user based upon at least one of a preference, policy or inference.

9. The system of claim 6, further comprising a data update component that at least one of generates or modifies data based upon a trigger received via the interface component.

10. The system of claim 1, wherein the interface component employs at least one of a tactile-equipped button, a tactile-equipped thumbwheel, a ‘soap’ device, a gesture-input device, or an ‘earPod’ device to facilitate eyes-free input.

11. A computer-implemented method of sightlessly retrieving data while engaged in an active communication session, comprising:
receiving a data request during the active communication session;
analyzing the data request; and
retrieving data based upon the analysis, wherein the data is personal information manager (PIM) data.

12. The computer-implemented method of claim 11, further comprising triggering the data request via an ‘eyes-free’ interface.

13. The computer-implemented method of claim 11, further comprising privately rendering an audible representation of content of the data to a user without interruption of the active communication session.

14. The computer-implemented method of claim 13, further comprising configuring the data based upon at least one of a preference, policy or inference.

15. The computer-implemented method of claim 11, further comprising updating a subset of the data based upon the data request.

16. The computer-implemented method of claim 11, further comprising generating additional data based upon the data request.

17. A system that manages PIM data during an active communication session, comprising:
means for trigging a retrieval request for a subset of the PIM data; and
means for privately conveying the subset of the PIM data to a user without interruption of the active communication session.

18. The system of claim 17, further comprising:
means for trigging a modification instruction; and
means for at least one of updating or modifying the PIM data as a function of the modification instruction.

19. The system of claim 17, further comprising means for configuring the subset of PIM data based upon at least one of a preference, policy or inference.

20. The system of claim 17, further comprising means for audibly notifying the user of the content of the subset of the PIM data.
